(19) United States
(12) Patent Application Publication
(10) Pub. No.: US 2025/0087474 A1
(43) Pub. Date: Mar. 13, 2025

(54) Electron Emitter for an Ion Reaction Device of a Mass Spectrometer and Methods of Operating the Same

(71) Applicant: DH Technologies Development Pte. Ltd., Singapore (SG)

(72) Inventors: Sebin CHERIAN, Singapore (SG); William LOYD, Sugar Land, TX (US); Pavel RYUMIN, Toronto (CA)

(73) Assignee: DH Technologies Development Pte. Ltd., Singapore (SG)

(21) Appl. No.: 18/832,984

(22) PCT Filed: Jan. 24, 2023
(86) PCT No.: PCT/IB2023/050608

§ 371 Date: Jul. 25, 2024

Related U.S. Application Data
(60) Provisional application No. 63/316,867, filed on Mar. 4, 2022.
(60) Provisional application No. 63/303,120, filed on Jan. 26, 2022.

(51) Int. Cl. H01J 49/00; H01J 49/08

(52) U.S. Cl. CPC H01J 49/0009; H01J 49/08

(57) ABSTRACT

Methods and systems for controlling a filament of an electron emitter associated with an ion reaction cell in accordance with various aspects of the present teachings may account for inter-filament and inter-instrument variability and can provide improved reproducibility in EAD experiments and ease of use. In some aspects, a method of operating an ion reaction device of a mass spectrometer system is provided. The method comprises applying a calibration drive voltage to a filament of an electron emitter associated with an ion reaction cell and determining a value representative of the calibration electron emission current generated by the filament while having the calibration drive voltage applied thereto. A calibration saturation voltage can be determined by iteratively increasing the calibration drive voltage applied to the filament and determining the value of the calibration electron emission current at each corresponding calibration drive voltage until the filament reaches a saturation condition.

### RELATED APPLICATIONS

This application claims priority to U.S. provisional application No. 63/303,120 filed on Jan. 26, 2022, entitled “Electron Emitter for An Ion Reaction Device of a Mass Spectrometer and Methods of Operating the Same,” and claims priority to U.S. provisional application No. 63/316,867 filed on Mar. 4, 2022, entitled “Electron Emitter for An Ion Reaction Device of a Mass Spectrometer and Methods of Operating the Same.” The entirety of these applications are incorporated herein by reference in its entirety.

### FIELD

The present teachings generally relate to ion reaction devices for use in mass spectrometry (MS), and more particularly, to electron emitters for generating electrons used in ion-electron reaction experiments within an ion reaction device.

### BACKGROUND

Mass spectrometry (MS) is an analytical technique for determining the structure of chemical substances with both qualitative and quantitative applications. MS can be useful for identifying unknown compounds, determining the composition of atomic elements in a molecule, determining the structure of a compound by observing its fragmentation, and quantifying the amount of a particular chemical compound in a mixed sample. Mass spectrometers detect chemical entities as ions such that a conversion of the analytes to charged ions must occur during the sampling process.

Some known mass spectrometers include one or more ion reaction devices, which fragment ions received from an ion source via collision with a neutral gas molecule (e.g., collision induced dissociation (CID)) and/or via interaction with another charged species. In electron activated dissociation (EAD), the charged species is an electron that impinges on an ion within the ion reaction device to result in the fragmentation of the ion. Known EAD mechanisms include electron capture dissociation (ECD) using electrons having kinetic energies of 0 to 3 eV, electron ionization dissociation (EID) using electrons with kinetic energy of greater than 3 eV, Hot ECD (electrons with kinetic energy of 5 to 10 eV), high energy electron ionization dissociation (HEEID) (electrons with kinetic energy greater than 13 eV), electron detachment dissociation (EDD), and negative ECD, all by way of non-limiting example. Usage of the term EAD herein should be understood to encompass all forms of electron-related dissociation techniques, and is not limited to the usage of electrons within any specific degree of kinetic energy, for example.

EAD mechanisms have been used in advanced MS devices to provide complimentary information to conventional CID as EAD tends to result in different fragmentation patterns while maintaining labile post-translational modifications, for example. As a result, EAD has been used in a wide range of applications for dissociating biomolecules such as proteomics in liquid chromatography-mass spectrometry/mass spectrometry (LC-MS/MS), top down analysis (no digestion), de novo sequencing (abnormal amino acid sequence finding), post translational modification studies (glycosylation, phosphorylation, etc.), and protein-protein interactions (functional study of proteins).

Ion-electron reactions have been performed in various devices such as in a Fourier transform ion cyclotron resonance (FT-ICR) mass spectrometer or in RF ion traps in which the electron beam is injected parallel to the ion injection/extraction direction or transverse to the ion injection/extraction direction. One example of a known EAD device is described in PCT Pub. No. WO2014/191821, entitled “Inline Ion Reaction Device Cell and Method of Operation,” the teachings of which are incorporated herein by reference in its entirety.

The electrons used in EAD are commonly generated by applying a voltage across a coated wire (e.g., a filament) associated with the ion reaction cell. However, such filaments exhibit a steep emission curve and a narrow range of operation, and can become degraded over time or if overheated, which may result in changes to the filament's emissivity due to evaporation of the filament wire material and/or evaporation of a coating on the filament. The risk of overdriving a filament is amplified in the higher-pressure environments typically utilized in EAD experiments, where residual oxygen may promote even quicker degradation. On the other hand, under driving the filament may yield poor fragmentation efficiency, thus making it challenging balance safe operation and good performance.

Wherein successful EAD operation generally requires accurate control of an electron beam injected into the ion reaction device, there remains a need for improved systems and methods for controlling the operation of a filament utilized to generate electrons for EAD.

### SUMMARY

Methods and systems for controlling a filament of an electron emitter associated with an ion reaction cell in accordance with various aspects of the present teachings may account for inter-filament and inter-instrument variability and can provide improved reproducibility in EAD experiments and ease of use.

In accordance with various aspects of the present teachings, a method of operating an ion reaction device of a mass spectrometer system is provided. The method comprises applying a calibration drive voltage to a filament of an electron emitter associated with an ion reaction cell and determining a value representative of the calibration electron emission current generated by the filament while having the calibration drive voltage applied thereto. A calibration saturation voltage can be determined by iteratively increasing the calibration drive voltage applied to the filament and determining the value of the calibration electron emission current at each corresponding calibration drive voltage until the filament reaches a saturation condition. An operating range for a drive voltage applied to the filament can then be determined based on the determined calibration saturation voltage.

The operating range for the drive voltage can be determined in a variety of manners in accordance with various aspects of the present teachings. For example, in some aspects, the operating range for the drive voltage can be determined to be a range from 0 V to the calibration saturation voltage. In some alternative aspects, the operating range for the drive voltage can be in a range from 0 V to said saturation voltage plus an offset.

In certain aspects, the operating range can be determined by obtaining a linear fit calibration function of a plurality of values of the calibration electron emission current relative to the corresponding calibration drive voltages, wherein the calibration electron emission current is in a log(I) domain. A maximum operating voltage can then be determined using the linear fit calibration function and a predetermined emission current threshold, wherein the operating range for the drive voltage can be determined to be a range from 0 V to the maximum operating voltage. In some related aspects, the predetermined emission current threshold can be selected to be greater than or equal to an emission current at which ion-electron reaction efficiency is not substantially increased.

After determining the operating range in a calibration procedure in accordance with the present teachings, a drive voltage can be applied to the filament during an ion-electron reaction experiment performed within the ion reaction cell, wherein the applied drive voltage is controlled to be within the operating range. In certain aspects, a user may select the drive voltage from the operating range to be applied during an ion-electron reaction experiment. Alternatively, in some aspects, the operating range for the drive voltage may be mapped to a current domain, and a user may select a desired current from the operating range mapped to the current domain.

In various aspects, the value representative of the calibration electron emission current may be determined by measuring the current at an entry gate disposed between the electron emitter and electrodes of the ion reaction cell.

In some aspects, the saturation condition may be identified by a linear portion of the value representing the calibration electron emission current on a log scale relative to the corresponding calibration drive voltage. Alternatively, in some certain aspects, the saturation condition may be identified by an inflection point in a plot of the value representing the calibration electron emission current versus the calibration drive voltage. For example, the inflection point may be identified by a change in a sign of the second derivative of the plot.

In accordance with various aspects of the present teachings, a mass spectrometer system is provided, the system comprising an ion reaction cell configured to receive ions from an ion source and an electron emitter configured to transmit into the ion reaction cell, the electron emitter having a filament configured to generate electrons when a drive voltage is applied thereto. The system may also comprise one or more voltage sources for providing the drive voltage to the filament and a controller, operably coupled to the one or more voltage sources, configured to: apply a calibration drive voltage to the filament of the electron emitter; determine a value representative of a calibration electron emission current generated by the filament while having the calibration drive voltage applied thereto; determine a calibration saturation voltage by iteratively increasing the calibration drive voltage applied to the filament and determining the value of the calibration electron emission current at each corresponding calibration drive voltage until the filament reaches a saturation condition; and based on the calibration saturation voltage, determine an operating range for the drive voltage applied to the filament during an ion-electron reaction experiment.

In certain aspects, the controller may be configured to determine the operating range by: obtaining a linear fit calibration function of a plurality of values of the calibration electron emission current relative to the corresponding calibration drive voltages, wherein the calibration electron emission current is in log(I) domain; and determining a maximum operating voltage using the linear fit calibration function and a predetermined emission current threshold, wherein the operating range for the drive voltage is determined to be a range from 0 V to the maximum operating voltage.

In certain aspects, after determining the operating range in the calibration procedure, the controller may be further configured to control the drive voltage to be within the operating range during an ion-electron reaction experiment performed within the ion reaction cell. In some related aspects, the controller may be configured to receive a user selection of the drive voltage from the operating range as input during ion-electron reaction experiment. Alternatively, in some aspects, the operating range for the drive voltage may be mapped to a current domain, and the controller can receive input from a user selecting the desired emission current during the ion-electron reaction.

The ion reaction cell can comprise any known or hereafter developed device within which EAD experiments may be performed. By way of example, in some aspects, the ion reaction cell can comprise a branched radiofrequency (RF) ion trap comprising eight L-shaped electrodes positioned axially at a distance relative to one another so as to provide an axial section exhibiting a central axis along which the ions are received from the ion source and two branched sections extending transversely from a central portion of said axial section and having a transverse axis along which electrons are received from the electron emitter. In some aspects, the system may also comprise a magnetic field generator for generating a magnetic field parallel to and along said transverse axis. Additionally or alternatively, in some aspects, an entry gate may be disposed between the electron emitter and the branched sections of the L-shaped electrodes, wherein the value representative of the calibration electron emission current may be measured at the entry gate.

In accordance with various aspects of the present teachings, a computer program product is provided, the computer program product comprising a non-transitory and tangible computer-readable storage medium whose contents include a program with instructions being executed on a processor to perform the methods described herein.

These and other features of the applicant's teachings are set forth herein.

### BRIEF DESCRIPTION OF THE DRAWINGS

The skilled person in the art will understand that the drawings, described below, are for illustration purposes only. The drawings are not intended to limit the scope of the applicant's teachings in any way.

FIG. 1 schematically depicts an exemplary ion reaction device utilized to perform EAD, the ion reaction device comprising an ion reaction cell and an electron emitter associated therewith.

FIG. 2 schematically depicts the exemplary electron emitter of FIG. 1 in additional detail.

FIG. 3 depicts an example technique for electron emitter control in which the filament drive voltage is directly set.

FIG. 4 depicts an example technique for electron emitter control in which the drive current is directly set.

FIG. 5 depicts electron capture efficiency data utilizing the example technique depicted in FIG. 4.

FIG. 6 depicts an example technique for electron emitter control which utilizes emission current feedback control to adjust the drive voltage.

FIG. 7 depicts emission current relative to drive voltage at two different kinetic energies when utilizing the example technique depicted in FIG. 6.

FIG. 8 schematically depicts an example mass spectrometer system having ion reaction cell and an electron emitter associated therewith in accordance with various aspects of the present teachings.

FIG. 9 depicts data regarding a value representative of emission current relative to drive voltage obtained during a calibration procedure in accordance with various aspects of the present teachings.

FIG. 10 depicts the data of FIG. 9 with the value representative of emission current on the log scale.

FIG. 11 depicts data regarding a value representative of emission current relative to drive voltage obtained during a calibration procedure in accordance with various aspects of the present teachings.

FIG. 12 is a flow chart of an example method for calibrating a filament of an electron emitter in accordance with various aspects of the present teachings.

FIGS. 13A-C depicts the collection of the data of FIG. 9 during a calibration procedure in accordance with various aspects of the present teachings.

FIG. 14 is a plot of a linear fit function obtained during the calibration procedure of FIGS. 9, 10, 12, and 13 to determine an operating range of the filament drive voltage in accordance with various aspects of the present teachings.

FIG. 15 depicts example data to determine an emission current threshold utilized to determine an operating range of the filament drive voltage of FIG. 14 in accordance with various aspects of the present teachings.

FIG. 16 is a block diagram that illustrates a computer system, upon which embodiments of the present teachings may be implemented in accordance with various aspects of the applicant's teachings.

### DETAILED DESCRIPTION

It will be appreciated that for clarity, the following discussion will explicate various aspects of embodiments of the applicant's teachings, while omitting certain specific details wherever convenient or appropriate to do so. For example, discussion of like or analogous features in alternative embodiments may be somewhat abbreviated. Well-known ideas or concepts may also not be discussed in any great detail for brevity. The skilled person will recognize that some embodiments of the applicant's teachings may not require certain of the specifically described details in every implementation, which are set forth herein only to provide a thorough understanding of the embodiments. Similarly, it will be apparent that the described embodiments may be susceptible to alteration or variation according to common general knowledge without departing from the scope of the disclosure. The following detailed description of embodiments is not to be regarded as limiting the scope of the applicant's teachings in any manner.

As used herein, the terms “about” and “substantially equal” refer to variations in a numerical quantity that can occur, for example, through measuring or handling procedures in the real world; through inadvertent error in these procedures; through differences in the manufacture, source, or purity of compositions or reagents; and the like. Typically, the terms “about” and “substantially” as used herein means 10% greater or lesser than the value or range of values stated or the complete condition or state. For instance, a concentration value of about 30% or substantially equal to 30% can mean a concentration between 27% and 33%. The terms also refer to variations that would be recognized by one skilled in the art as being equivalent so long as such variations do not encompass known values practiced by the prior art.

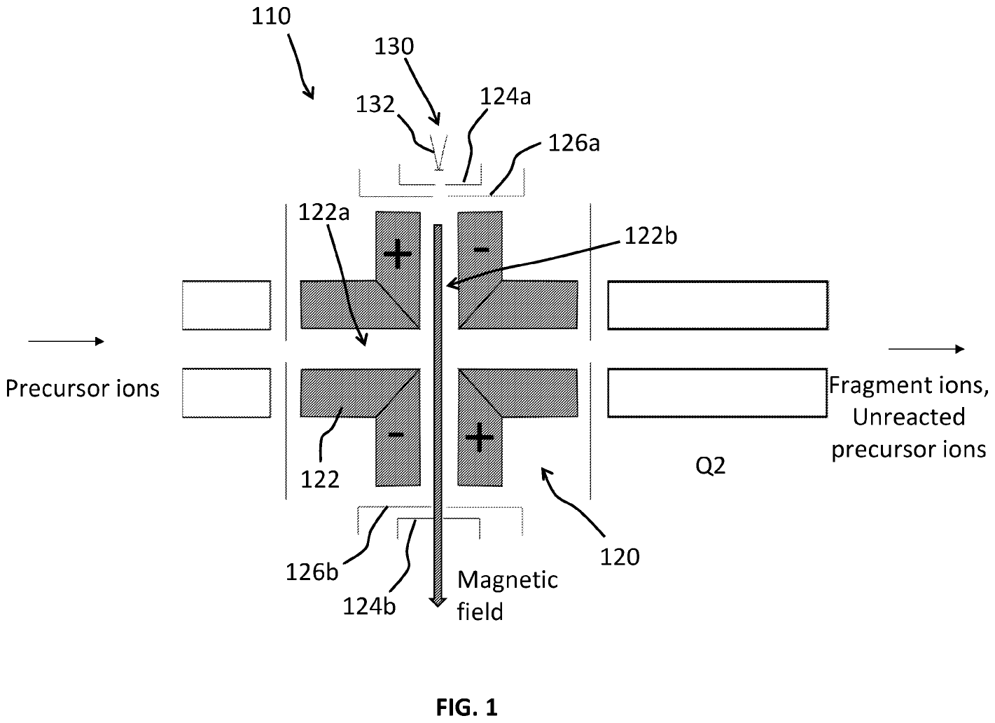

FIG. 1 schematically depicts an example configuration of an ion reaction device 110 comprising an ion reaction cell 120 and electron emitter 130 having a filament 132 for generating electrons for performing EAD reactions within the reaction cell 120. In some example aspects, the filament 132 can be an iridium or a yttria-coated iridium filament, though other materials may also be used. By way of non-limiting example, the filament 132 can be tungsten or a thoriated tungsten filament. As shown, the example ion reaction device 110 is disposed downstream from a Brubaker lens, which, for example, may help focus ions (e.g., precursor ions) ejected from a mass analyzer (not shown) into the ion reaction cell 120. Mass analyzer Q2 is disposed downstream from the ion reaction cell 120 for processing (e.g., mass filtering) fragment ions and/or unreacted precursor ions received from the ion reaction cell 120 prior to detection by a detector (not shown). A cooling gas source (not shown) may provide a cooling gas, such as helium (He) and nitrogen (N₂), to maintain the ion reaction device 110 at a selected operating pressure (e.g., between about 10⁻² Torr to about 10⁻⁴ Torr). It will be appreciated by those skilled in the art that the depicted ion reaction device 110 represents just one possible configuration of a device suitable for interacting ions and electrons, and that any known or hereafter developed ion reaction device utilizing a filament to generate electrons may be modified in accordance with the present teachings.

As shown in FIG. 1, the ion reaction cell 120 generally comprises eight L-shaped electrodes 122 (only four of which are seen) spaced so as to define a first pathway 122a through which ions (e.g., precursor ions) received from an ion source are transmitted. The L-shaped electrodes 122 also define a second pathway 122b extending along a transverse axis and along which electrons generated by the electron emitter 130 may be injected. As indicated by the signs on the four depicted electrodes 122, RF signals of opposite phases may be applied to the L-shaped electrodes 122 to generate RF fields within the reaction cell 120 for controlling the motion of ions therein. Additional details regarding the generation of example suitable RF fields in such a reaction cell 120 may be found in PCT Pub. No. WO2014/191821, entitled “Inline Ion Reaction Device Cell and Method of Operation,” the teachings of which are incorporated herein by reference in its entirety.

As shown in FIG. 1, the ion reaction device 110 may also include one or more suitable electrode gates 124a disposed proximate the first axial end of the second pathway 122b (e.g., between the electrodes 122 and the filament 132) to control the entrance of electrons into the reaction cell 120. In some aspects, an electrode gate 124b may also be disposed proximate the opposite axial end of the second pathway, for example, if an additional or alternate electron emitter is disposed at this second end. As shown, the ion reaction device 100 may also include one or more pole electrodes 126a,b (e.g., a plate electrode or lens) disposed at opposite ends of the second pathway 122b. By way of non-limiting example, the pole electrode(s) 126a,b may be configured to prevent ions contained within the reaction cell 120 from leaking from the axial ends of the second pathway 122b. For example, a positive electric bias on pole electrode(s) 126a,b may serve to repel like charged ions and/or reaction products (e.g., fragment ions) from escaping the openings at the axial ends of the second pathway 122b.

Electrons generated by the electron emitter 130 may be focused along the second pathway 122b via a magnetic field such that the electrons and ions may interact at the intersection of the first and second pathways 122a,b. By way of non-limiting example, in a typical setup, the EAD reaction cell 120 may be operated with +15-30 V relative bias on the extraction gate lens 124a and +5-10 V potential on the pole electrode 126a to facilitate electron extraction from the electron emitter 120 into the reaction cell 120. The electrons and ions may interact as the ions are trapped within the reaction cell 120 or as the ions are being transported continuously therethrough.

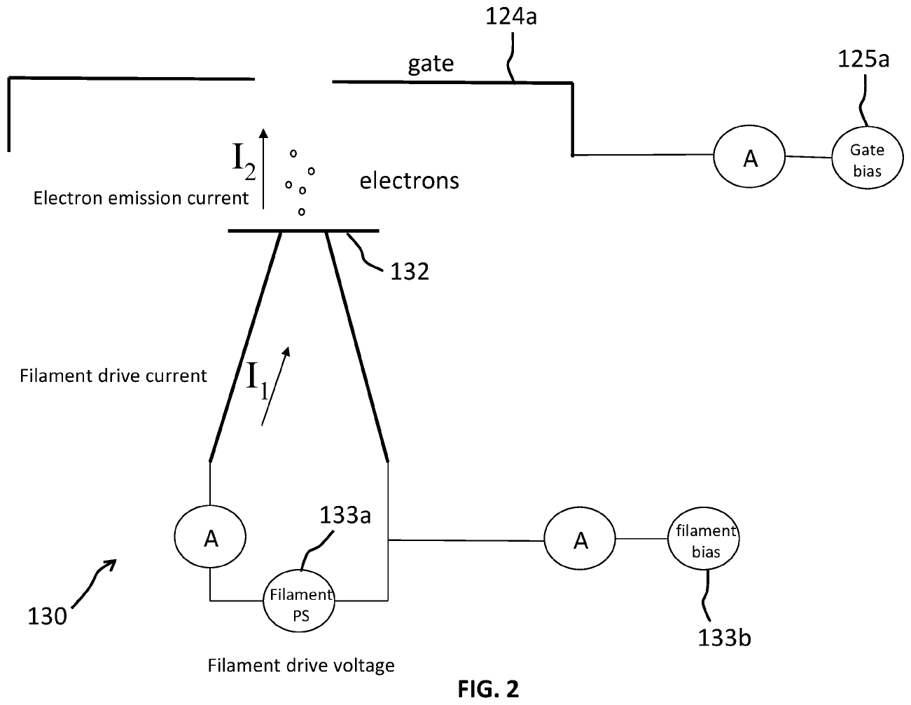

With reference now to FIG. 2, the exemplary electron emitter 130 and gate electrode 124a of FIG. 1 are depicted in additional detail. As shown in some example aspects, the filament 132 may be driven with a floating power supply 133a and a bias power supply 133b, with the filament drive voltage 133a being effective to generate a filament drive current (I₁) through the filament 132, thereby heating the filament 132 to generate electrons. As schematically indicated, the electron emission current (12) is the flux of the electrons generated by the filament 132 and directed toward the gate electrode 124a, which may be maintained at a bias voltage (e.g., by power supply 125a).

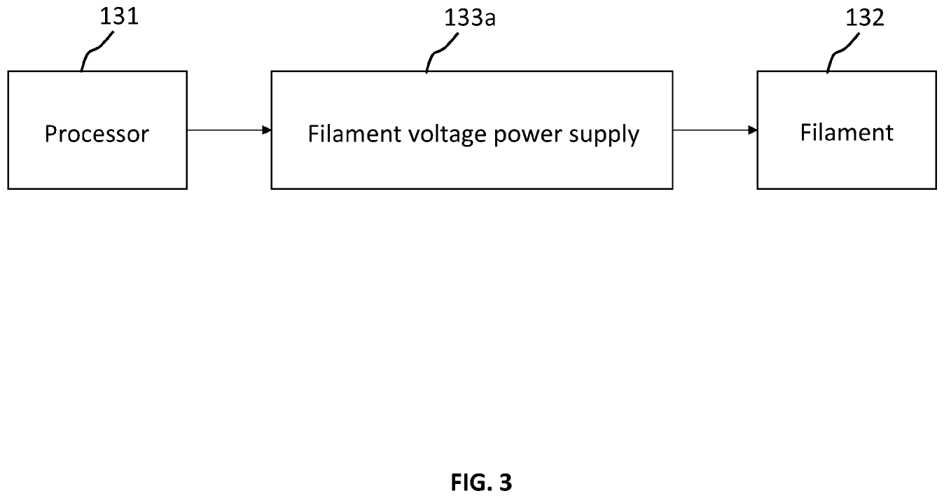

Various techniques for attempting to control the temperature of the filament 132 can complicate efficient operation of the filament 132, and hence, the EAD device (e.g., ion reaction device 110 of FIG. 1). For example, with reference to an example control scheme depicted in FIG. 3, the inventors have found that directly setting the drive voltage applied to the filament 132 by the filament voltage power supply 133a (e.g., via control signals provided by a processor 131) can fail to account for inherent variability in the electrical resistance, thermal path, and coating condition of nominally identical filaments such that the drive voltage setting applied to a filament in one instrument may damage the filament of another.

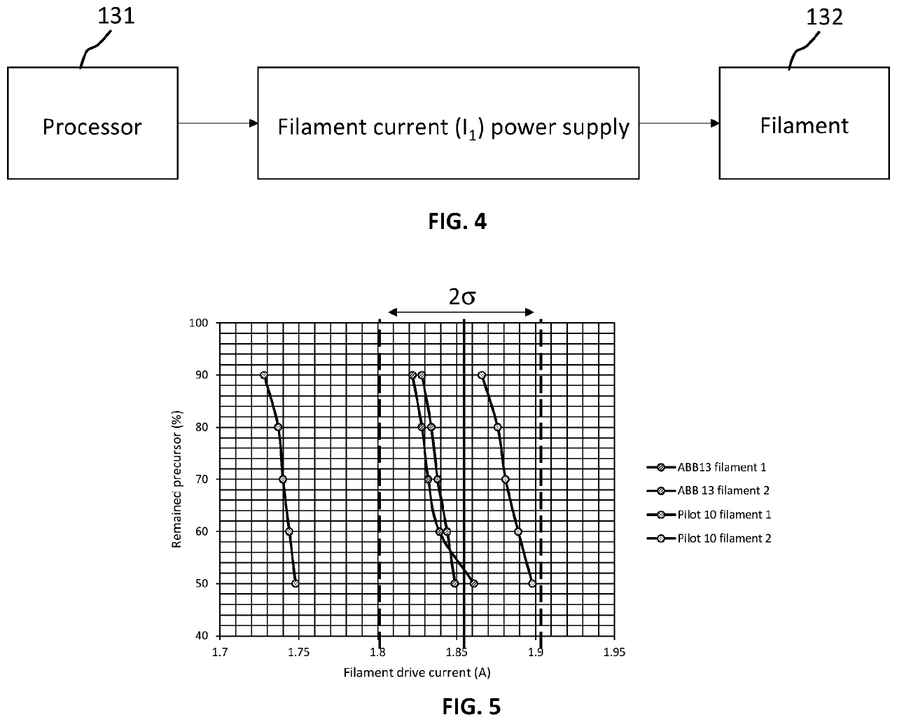

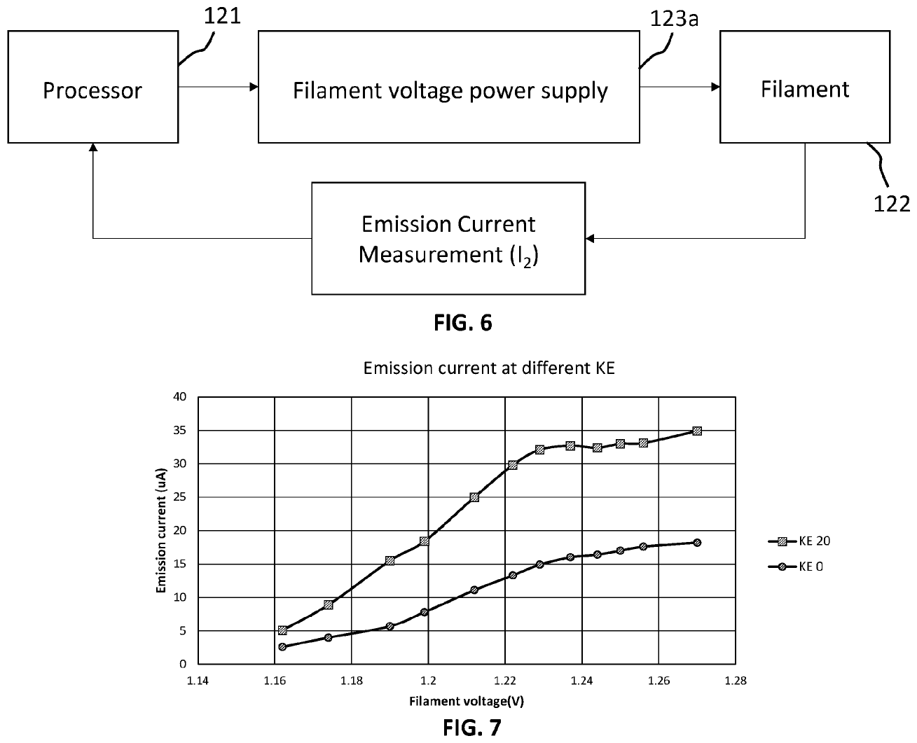

Alternatively, while direct control of the drive current as schematically depicted in FIG. 4 may address variability in electrical resistances between wires (e.g., the processor 131 provides the drive voltage necessary to obtain a selected drive current I₁), such a technique may still fail to account for differences in the thermal path and/or the condition of the filament's surface coating. FIG. 5 depicts electron capture efficiency curves when utilizing two filaments in each of two similar EAD reaction devices with the filament drive current (I₁) set to various values as in the control scheme depicted in FIG. 4. Reaction efficiency of the EAD devices was determined by measuring the amount of unreacted precursor Neurotensin [M+3H]³⁺ after being subjected to ECD under otherwise identical experimental conditions. The depicted confidence interval is calculated based on the data from six instruments each equipped with two filaments. The inter-instrument variability in the drive current (I₁) required to provide similarly-efficient ECD reactions in FIG. 5 suggests that utilizing a direct setting of drive current (I₁) as in the example control scheme depicted in FIG. 4 may fail to provide a standardized method for controlling electron emission (12 of FIG. 2) across multiple instruments.

Whereas the techniques of FIGS. 3 and 4 respectively set the filament drive voltage 133a and drive current (I₁) to particular, fixed values, the example control scheme depicted in FIG. 6 instead adjusts the filament drive voltage applied by the filament voltage power supply 133a based on a feedback measurement of the emission current (e.g., 12, the flux of electrons emitted by the filament 132). However, in an example EAD reaction cell operating with +15-30 V relative bias on the extraction gate lens 124a and +5-10 V potential on the pole electrode 126a to facilitate electron extraction from the electron emitter 120, an electron may have insufficient energy to overcome the barrier between the pole 126a and electrodes 122 of the EAD reaction cell 120 and thus may be returned to the filament 132. Such an electron would not contribute toward the averaged emission current measurement (12). Thus, the number of electrons transmitted to the EAD cell 120 may vary depending on the relative bias between the filament 132 and the electrodes 122 of the EAD cell 120. Moreover, where the relative bias between the filament 132 and the electrodes 132 of the EAD cell 120 defines the kinetic energy of the electrons utilized in the EAD reaction, the relative bias introduces an interdependency between the emission current (12) and the kinetic energy of the electrons, which are both parameters that are selected or adjusted during EAD reaction tuning, for example, depending on the type of EAD reaction the user wishes to have performed. FIG. 7 depicts exemplary plots of emission current (12) acquired at KE=0 eV (e.g., for ECD) and KE=20 (e.g., for HEEID) at various filament drive voltages settings Further, it can be seen that at a filament drive voltage of about 1.23V, the corresponding increase in the emission current slows, which is likely due to space charge saturation. Such an effect may lead to the problem that certain emission currents achievable and desirable at KE=20 are unachievable at KE=0. That is, utilizing an emission current target in a feedback control loop as in the example control scheme of FIG. 6 may overdrive filament drive currents at KE=0 and can result in permanent filament damage. The problem stems from a very different emission curves at low and high extraction voltages, which in part depend on the set kinetic energy of the EAD reaction, an important parameter for EAD reaction. As such, the feedback based technique depicted in FIG. 6 may significantly complicate the control of the system and/or be unsatisfactory in EAD techniques.

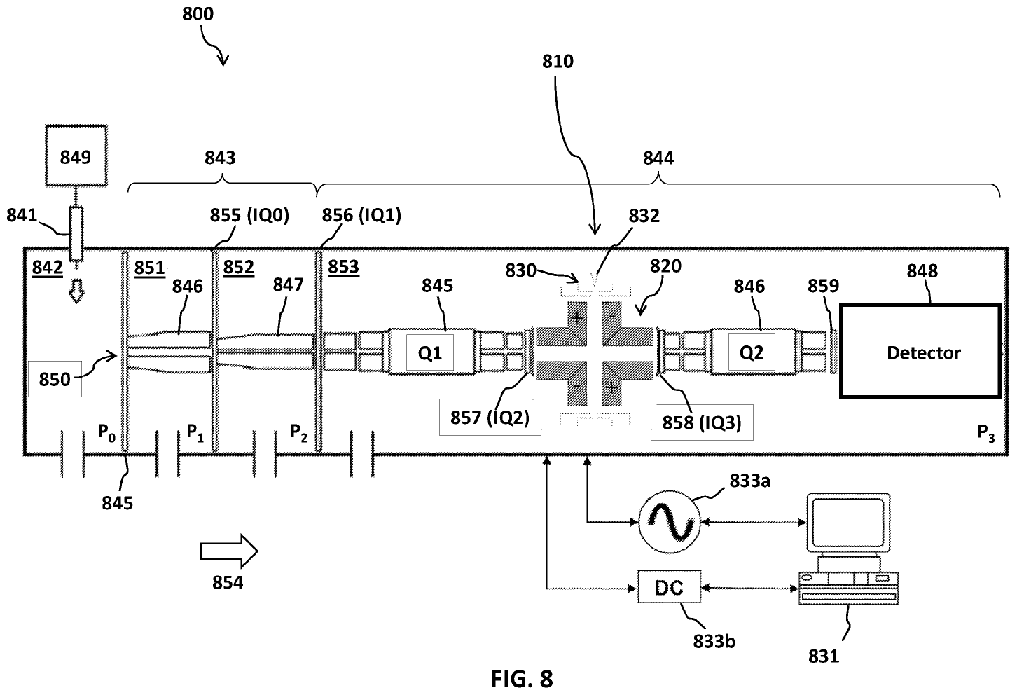

FIG. 8 schematically depicts an example mass spectrometer system 800 having ion reaction device 810 comprising an ion reaction cell 820 and an electron emitter 830 associated therewith in accordance with various aspects of the present teachings. As shown, the system 800 includes a controller 831, operatively coupled to the electron emitter 830 and one or more power supplies 835a,b, for operating the filament 832 in accordance with the present teachings. By way of example, as discussed otherwise herein, the controller 830 may be programmed to provide control signals in order to determine an operating range of the drive voltage and/or drive current applied to the filament 832 during an ion-electron experiment.

As shown, the exemplary mass spectrometer system 800 can comprise an ion source 841 for generating ions within an ionization chamber 842, an upstream section 843, and a downstream section 844. The upstream section 843 is configured to perform initial processing of ions received from the ion source 841, and includes various elements such as a curtain plate 845 and one or more ion guides 846, 847. The downstream section 844 includes one or more mass analyzers 845 and 846 (also referred to herein as Q1 and Q2, respectively), the EAD reaction device 810 disposed therebetween, and a detector 848. As shown, for example, the system 800 includes an RF power supply 833a and DC power supply 833b that can be controlled by a controller 831 so as to apply electric potentials having RF, AC, and/or DC components to the various components of the system 800. For example, as discussed otherwise herein, the controller 831 may control the DC signals applied as the filament drive voltage to generate ions during an EAD reaction. The same or different power supplies may also control the RF and/or DC signals applied to the various rod sets, mass analyzers (e.g., Q1 and Q2), the ion reaction cell 820, and the various ion optical elements for controlling transmission of ions through the mass spectrometer system 800.

The ion source 841 can be any known or hereafter developed ion source for generating ions and modified in accordance with the present teachings. Non-limiting examples of ion sources suitable for use with the present teachings include atmospheric pressure chemical ionization (APCI) sources, electrospray ionization (ESI) sources, continuous ion source, a pulsed ion source, an inductively coupled plasma (ICP) ion source, a matrix-assisted laser desorption/ionization (MALDI) ion source, a glow discharge ion source, an electron impact ion source, a chemical ionization source, or a photo-ionization ion source, among others. Additionally, as shown in FIG. 8, the system 800 can include a sample source 849 configured to provide a sample to the ion source 841. The sample source 849 can be any suitable sample inlet system known in the art. By way of example, the ion source 841 can be configured to receive a fluid sample from a variety of sample sources, including a reservoir containing a fluid sample that is delivered to the sample source (e.g., pumped), a liquid chromatography (LC) column, a capillary electrophoresis device, and via an injection of a sample into a carrier liquid. In the example depicted in FIG. 8, the ion source 841 comprises an electrospray electrode, which can comprise a capillary fluidly coupled to the sample source 849 (e.g., through one or more conduits, channels, tubing, pipes, capillary tubes, etc.), and which terminates in an outlet end that at least partially extends into the ionization chamber 842 to discharge the liquid sample therein.

One or more power supplies can supply power to the ion source 841 with appropriate voltages for ionizing the analytes in either positive ion mode (analytes in the sample are protonated, generally forming the cations to be analyzed) or negative ion mode (analytes in the sample are deprotonated, generally forming the anions to be analyzed). Further, the ion source 841 can be nebulizer-assisted or non-nebulizer assisted. In some embodiments, ionization can also be promoted with the use of a heater, for example, to heat the ionization chamber so as to promote dissolution of the liquid discharged from the ion source.

With continued reference to FIG. 8, the analytes, contained within the sample discharged from the ion source 841, can be ionized within the ionization chamber 845, which is separated from the upstream section 843 by the curtain plate 845. The curtain plate 30 can define a curtain plate aperture 850, which is in fluid communication with the upstream section 843. Although not shown in FIG. 8, the system 800 can include various other components. For example, the system 800 can include a curtain gas supply (not shown) that provides a curtain gas flow (e.g., of N₂) to the upstream section 843 of the system 800. The curtain gas flow can aid in keeping the downstream section 844 of the mass spectrometer system 800 clean (e.g., by de-clustering and evacuating large neutral particles). For example, a portion of the curtain gas can flow out of the curtain plate aperture 850 into the ionization chamber 842, thereby preventing the entry of droplets and/or neutral molecules through the curtain plate aperture 850.

The ions generated by the ion source 841 generally travel towards the vacuum chambers 851, 852, 853, in the direction indicated by the arrow 854 in FIG. 8. Initially, these ions can be successively transmitted through the elements of the upstream section 843 (e.g., curtain plate 850, ion guide 846, and ion guide 847) to result in a narrow and highly focused ion beam (e.g., along the central longitudinal axis of the system 800) for further processing (e.g., m/z-based analysis, fragmentation) within the downstream portion 844. The ions generated by the ion source 841 enter the upstream section 843 to traverse one or more intermediate vacuum chambers 851, 852 and/or ion guides 846, 847 having elevated pressures greater than the high vacuum chamber 853 within which the mass analyzers are disposed. As shown, for example, the ions traverse the ion guide 846 (also referenced herein as “QJet”), which provides collisional cooling and radial focusing of the ions into an ion beam using a combination of gas dynamics and radio frequency fields. The ion guide 846 transfers the ions through an exit aperture in the ion lens 855 (also referenced herein as “IQ0”) to subsequent ion optics such as ion guide 847. The ion guide Q0 847 can be an RF ion guide and can comprise a quadrupole rod set. This ion guide Q0 847 can be positioned in a second vacuum chamber 852 and so as to transport ions through an intermediate pressure region prior to delivering ions through the subsequent optics (e.g., IQ1 lens 856) to the downstream section 844 of system 800.

The ionization chamber 842 can be maintained at a pressure P₀, which can be atmospheric pressure or a substantially atmospheric pressure. However, in some embodiments, the ionization chamber 842 can be evacuated to a pressure lower than atmospheric pressure. The pressure (P₁) of the vacuum chamber 851 can be maintained at a pressure ranging from approximately 100 mTorr to approximately 50 Torr, although other pressures can be used for this or for other purposes. For example, in some aspects, the first vacuum chamber 851 can be maintained at a pressure above about 100 mTorr. In certain implementations, the first vacuum chamber 851 can be maintained at a pressure in a range from about 0.5 Torr to about 10 Torr. Alternatively or additionally, the first vacuum chamber 851 can be maintained at a pressure ranging from about 10 Torr to about 50 Torr. Similarly, vacuum chamber 852 can be evacuated to a pressure (P₂) that is lower than that of first vacuum chamber 851 (i.e., P₁). For example, the second vacuum chamber 852 can be maintained at a pressure of about 3 to 15 mTorr, although other pressures can be used for this or for other purposes.

Ions traversing the quadrupole rod set Q0 847 pass through the lens IQ1 856 and into the adjacent quadrupole rod set Q1 845 in the downstream section 844, which can be situated in a vacuum chamber 853 that can be evacuated to a pressure (P₃) that can be maintained lower than that of the ion guide 846 chamber 851 and the ion guide Q0 847 chamber 852. For example, the vacuum chamber 853 can be maintained at a pressure less than about 1×10⁻⁴ Torr or lower (e.g., about 5×10⁻⁵ Torr), though other pressures can be used for this or for other purposes. As will be appreciated by a person of skill in the art, the quadrupole rod set Q1 845 can be operated as a conventional transmission RF/DC quadrupole mass filter that can be operated to select an ion of interest and/or a range of ions of interest. For example, the quadrupole rod set Q1 845 can be provided with RF/DC voltages suitable for operation in a mass-resolving mode (e.g., by one or more voltage supplies 833a/b). As should be appreciated, taking the physical and electrical properties of mass analyzer Q1 845 into account, parameters for an applied RF and DC voltage can be selected so that Q1 845 establishes a transmission window of chosen m/z ratios, such that these ions can traverse Q1 845 largely unperturbed. Ions having m/z ratios falling outside the window, however, do not attain stable trajectories within the quadrupole and can be prevented from traversing the quadrupole rod set Q1 845. It should be appreciated that this mode of operation is but one possible mode of operation for Q1 845. By way of example, the lens IQ2 857 between Q1 845 and ion reaction device 810 can be maintained at a much higher offset potential than Q1 845 such that the quadrupole rod set Q1 845 can be operated as an ion trap. In such a manner, the potential applied to the entry lens IQ2 857 can be selectively lowered (e.g., mass selectively scanned) such that ions trapped in Q1 845 can be accelerated into ion reaction device 810 within which an EAD reaction may be performed.

The ion reaction device 810 can, in some aspects, be disposed in a pressurized compartment that is operated at a selected operating pressure so as to cool (e.g., slow) the ions entering ion reaction device 810. For example, a cooling gas source (not shown) may provide a cooling gas (e.g., helium, nitrogen, etc.) to maintain the ion reaction device 810 at a selected operating pressure in a range of between about 10⁻² Torr to about 10⁻⁴ Torr, though other pressures can be used for this or for other purposes. By way of example, in some EAD experiments, the quadrupole rod set Q1 845 can be operated to transmit to the ion reaction device 810 precursor ions exhibiting a selected range of m/z for fragmentation into product ions via reaction with electrons within ion reaction device 810. In MS mode, the electron emitter 830 may be turned off and the RF and DC voltages applied to the electrodes of the ion reaction cell 820 adjusted such that the ions transmitted from the quadrupole rod set Q1 845 are transmitted through the ion reaction device 810 largely unperturbed (e.g., without interaction with electrons).

Unreacted precursor ions and/or ion-electron reaction products that are transmitted by ion reaction device 810 can pass into the adjacent quadrupole rod set Q2 846, which is bounded upstream by IQ3 858 and downstream by the exit lens 859. As will be appreciated by a person skilled in the art, the quadrupole rod set Q2 846 can be operated at a decreased operating pressure relative to that of the ion reaction device 810, for example, less than about 1×10⁻⁴ Torr (e.g., about 5×10⁻⁵ Torr), though other pressures can be used for this or for other purposes. As will be appreciated by a person skilled in the art, quadrupole rod set Q2 846 can be operated in a number of manners, for example, as a scanning RF/DC quadrupole, as a linear ion trap, or as a RF-only ion guide to allow the ions to pass therethrough unperturbed. Following processing or transmission through quadrupole rod set Q2 846, the ions can be transmitted to the detector 848 (e.g., a Faraday cup or other ion current measuring device, a time-of-flight spectrometer) effective to detect the ions transmitted by the quadrupole rod set Q2 846.

A person skilled in the art will appreciate in light of the present teachings that one or more of the depicted example mass analyzers (e.g., Q1 rod set 845 and Q2 rod set 846) may have a variety of configurations for transmit ions into and/or receive ions from the ion reaction device 810. Indeed, a person skilled in the art will appreciate that any known mass analyzer(s) (e.g., one or more ion trap(s)) may be modified in view of the present teachings to inject and/or receive ions from the ion reaction device 810. By way of non-limiting example, while for convenience, the mass analyzers 845, 846 are described herein as being quadrupoles having elongated rod sets (e.g., having four rods), a person of ordinary skill in the art should appreciate that these elements can have other suitable configurations. For instance, it will be appreciated that the one or more mass analyzers 845, 846 can be any of triple quadrupoles, linear ion traps, quadrupole time of flights, Orbitrap or other Fourier transform mass spectrometers, all by way of non-limiting examples.

Calibration procedures in accordance with various aspects of the present teachings may be performed to determine an operating range of the filament drive voltage, which can in certain aspects help account for inter-filament and inter-instrument variability and may provide improved experimental reproducibility and ease of use when performed EAD reactions.

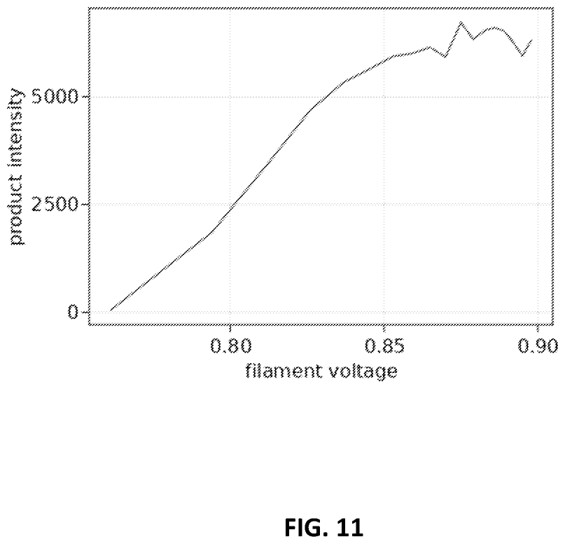

In various aspects, such calibration procedures described herein may be performed one or more times while operating an ion reaction device. By way of non-limiting example, calibration procedures in accordance with various aspects of the present teachings may be performed under the direction of a user and/or automatically at system start-up, intermittently, after a pre-determined duration of operation, or when switching experimental conditions (e.g., when a user desired to apply a different kinetic energy for a particular EAD technique). In an example embodiment of a calibration procedure applied to the ion reaction device 810 of FIG. 8, the calibration procedure may be initiated by applying a calibration drive voltage to the filament 832 of the electron emitter 830, for example, prior to the ion reaction device 810 receiving ions from the quadrupole mass analyzer 856. Initially, the calibration drive voltage may be selected to be a value sufficiently low that the filament 832 will not be overdriven. While the filament 832 has the calibration drive voltage applied thereto, a value representative of a calibration electron emission current (e.g., 12 of FIG. 2) may be determined. By way of non-limiting example, a value representative of the electron emission current (12) may be obtained by measuring electrical changes proximate the emitter 820, such as at the gate electrode 124a of FIG. 2. In some other example aspects, the value representative of the electron emission current may alternatively be determined based on monitoring a calibration electron-ion reaction within the ion reaction device 810. By way of example and as further discussed below with reference to FIG. 11, the intensity of product ions resulting from electron-ion reactions of calibrant precursor ion transmitted into the ion reaction device 810 may be detected to indicate the electron emission current, for example, where increased emission current may generate increased electron-ion interaction and therefore increased intensity of product ions.

Thereafter, the calibration drive voltage applied to the filament 832 may be iteratively increased (e.g., stepped up) and the corresponding change in the value representative of the calibration electron emission current (12) detected, for example, until a saturation condition is detected at the filament 832, as otherwise discussed herein. The filament drive voltage at the saturation condition, which may be referred to as the calibration saturation voltage, may thus be utilized (e.g., by the controller 831) to determine an operating range for the filament drive voltage. In certain aspects, after determining an operating range for the filament drive voltage utilizing a calibration procedure as described herein, the drive voltage can be controlled to be maintained within the operating range during an ion-electron reaction. By way of example, a user may select from the operating range, a value for the filament drive voltage and/or filament drive current at which the electron emitter 830 is to be operated.

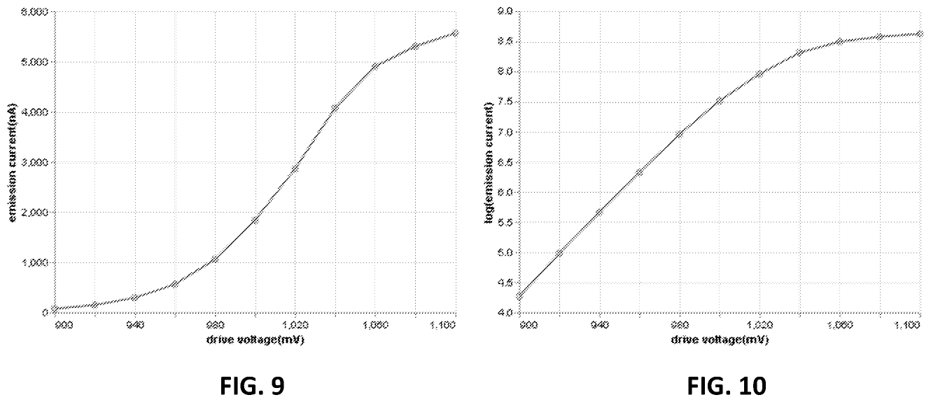

FIGS. 9 and 10 depict example data regarding changes in the value representative of emission current (e.g., I₂ of FIG. 2) as the filament drive voltage applied to the filament 832 is iteratively increased during a calibration procedure in accordance with various aspects of the present teachings. The data was obtained while operating a filament 832 with the electron KE set at 0 eV and with gate and pole voltages biased by 30V relative to the filament 832 respectively. The operating pressure inside the ion reaction cell 810 was maintained at ˜10 mTorr during this calibration procedure. In particular, FIG. 9 shows a collection current measurement as determined at the entry gate lens (e.g., gate 124a of FIG. 2). FIG. 10 depicts the corresponding log plot for the data in FIG. 9.

In accordance with various aspects of the present teachings, a controller (e.g., controller 831 of FIG. 8) may determine the calibration saturation voltage in a variety of manners. With reference to the emission current data depicted in FIG. 9, for example, the inflection point in the emission current vs. filament drive voltage graph may be identified by the controller as representing the calibration saturation voltage. By way of non-limiting example, the controller 831 may identify the inflection point based on a change in sign of the second derivative of the plot of FIG. 9. It will be appreciated by a person skilled in the art that the second derivative indicates that the concavity of the plot changes at about 1020 mV, where the plot is concave up to the left of the inflection point and concave down to the right.

Alternatively, with reference to the log plot of FIG. 10, it will be appreciated that the leftmost part of the log plot graph is almost linear, while a complete graph in log coordinates is non-linear. In certain aspects of the present teachings, the controller 831 may utilize the linearity of the log plot to detect the saturation point detection (e.g., about 1020 mV in FIG. 10).

Whereas FIGS. 9 and 10 depict plots of an example value representative of the emission current (e.g., electrical changes proximate the emitter 820, such as at the gate electrode 124a of FIG. 2, representative of I₂) relative to the filament drive voltage in accordance with various aspects of the present teachings, FIG. 11 depicts an example plot generated while monitoring a calibration electron-ion reaction in order to determine a calibration saturation voltage. For example, as noted above, a value representative of the emission current may be determined in accordance with various aspects of the present teachings by monitoring the intensity of product ions resulting from electron-ion reactions of calibrant precursor ion transmitted into the ion reaction device 810 while the drive voltage applied to the filament 832 is iteratively increased. In particular, the example plot of FIG. 11 depicts the detected intensity of a singly-charged product ion [M+NH₃]⁺ following the reaction of a precursor ion [M+2NH₃]²⁺ (e.g., Triacetyl-β-cyclodextrin) with an electron generated by the filament 832 as the precursor ion is transmitted into the ion reaction device 810. As will be appreciated from FIG. 11, for example, the increased electron-ion interaction results from increased electron emission current, thereby resulting in increased detection of product ions. As shown, the plot exhibits a similar inflection point to that of FIG. 9, which can be utilized to identify the saturation point as discussed otherwise herein. In some example aspects, when utilizing an electron-calibrant reaction as being indicative of the electron emission current, the number of electrons injected into the ion reaction cell 810 may be limited as described, for example, in U.S. Patent Pub. No. 20210351026, filed Oct. 8, 2019 and entitled “Electron beam throttling for electron capture dissociation,” the teachings of which are hereby incorporated by reference in its entirety. In this manner, the present teachings may reduce the occurrence of secondary reactions of the product ions [M+NH₃]⁺ with another electron such that such secondary interactions are insignificant relative to the primary reactions of the precursor ions [M+2NH₃]²⁺ with the electrons.

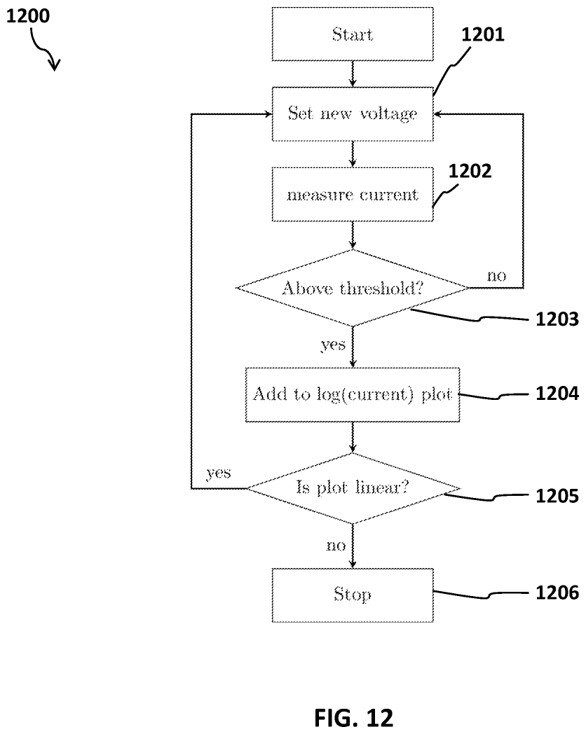

FIG. 12 depicts an example algorithm 1200 that can be applied by the controller 831 to detect the saturation point, which can be utilized to determine an operating range for the filament drive voltage and/or drive current in accordance with various aspects of the present teachings. Specifically, as depicted in FIG. 12, the example calibration procedure may start with the application of a filament drive voltage to the filament in block 1201. A value representative of the electron emission current (e.g., I₂) is determined in block 1202. If no current is detected and/or the value is not above a threshold (e.g., 0.1 μA) as at block 1203, the procedure 1200 may return to block 1201 and the filament drive voltage increased to a new value. This process may repeat one or more times until the filament drive voltage is increased sufficiently such that the value representative of the electron emission current exceeds the threshold in block 1203.

As shown in block 1204, each filament drive voltage and the log of the corresponding value representative of the electron emission current may be plotted as in FIG. 10, for example. At block 1205, it may be determined (e.g., by controller 831) whether the plot of the value representative of the electron emission current versus the log of the filament drive voltage remains linear. By way of example, the controller 831 can apply a linear fit function to the plot of FIG. 10 upon each new addition of a calibration point. If the plot remains linear with the newly-added calibration point as determined at block 1205 (e.g., the linear fit is within a given goodness of fit threshold), the calibration procedure 1200 may return to block 1201, where the filament drive voltage is again increased. However, if the linear fit function no longer shows acceptable goodness of fit upon the most recent addition of a calibration point, the calibration procedure 1200 terminates at block 1206 For example, the filament drive voltage may no longer be iteratively increased (as in block 1201) and the controller may determine the calibration saturation voltage to be the last calibration drive voltage in which sufficient linearity in the plot of FIG. 10 is maintained. As discussed below, the calibration saturation voltage may then be utilized to determine an operating range for the filament drive voltage and/or current to be used during ion-electron reaction experiments (e.g., while ions are being transmitted into the ion reaction cell)

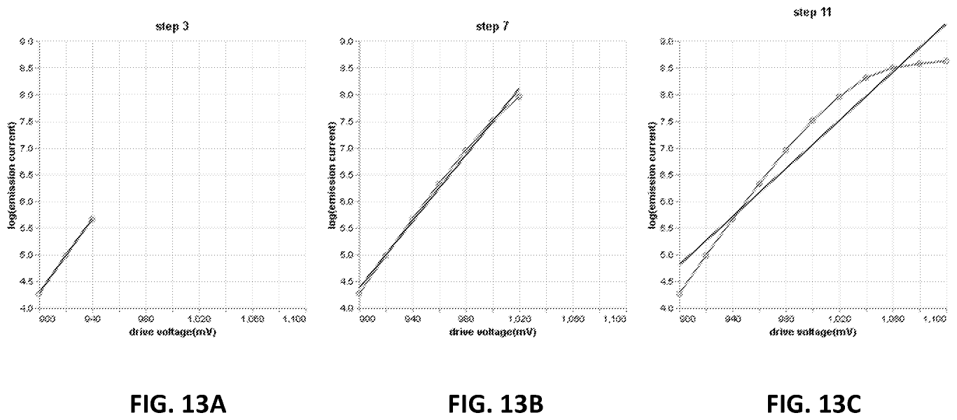

With reference now to FIGS. 13A-C, further example detail of the procedure 1200 are schematically depicted as the filament voltage is ramped and the value representative of the electron emission current is detected. As shown in FIGS. 13A-C, points above zero are selected for further processing (e.g., as in block 1203) and linear regression and corresponding goodness of fit is calculated for those points (e.g., as in block 1205) as the voltage is stepped. If goodness of fit falls below certain threshold, the calibration acquisition is stopped (e.g., as in block 1206). As shown, data at step 3 of the filament drive voltage increase shows almost perfect linear fit (FIG. 13A), while the linear regression fails to sufficiently fit the data at step 11 (FIG. 13C). Indeed, as shown in FIG. 13B, points up to step 6 are considered linear such that the procedure stops automatically following the application of increased filament drive voltage at step 7 according to the example method of FIG. 12.

As noted above, a controller (e.g., controller 831 of FIG. 8) may determine the calibration saturation voltage in a variety of manners. For example, though FIG. 12 depicts a procedure 1200 that utilizes a linear fit function applied to calibration data of the value representative of the electron emission current relative to the log of the filament drive voltage, in some alternative aspects, controller 831 may instead determine a saturation voltage based on the value representative of the electron emission current versus the filament drive voltage (e.g., as in FIGS. 9 and 11). For example, at block 1205 of FIG. 12, the calibration saturation voltage may be determined to be the inflection point in the plot of the value representative of the electron emission current versus the filament drive voltage as depicted in FIG. 9. By way of non-limiting example, the controller may identify the inflection point based on a change in sign of the second derivative of the plot of FIG. 9.

Upon determination of the calibration saturation voltage (e.g., according to the procedure 1200 of FIG. 12), an operating range of the filament drive voltage can then be determined based on the calibration saturation voltage in accordance with some aspects of the present teachings. Voltages within the operating range can, for example, generate electron emission currents for performing an EAD reaction while preventing the filament from being overdriven. In some aspects, the filament drive voltage operating range can be determined to be in a range extending between the voltage at which the value representative of the electron emission current is above a threshold (e.g., 0.1 μA) as determined in block 1203 in FIG. 12 to the calibration saturation voltage determined at termination of the calibration procedure 1200 at block 1206.

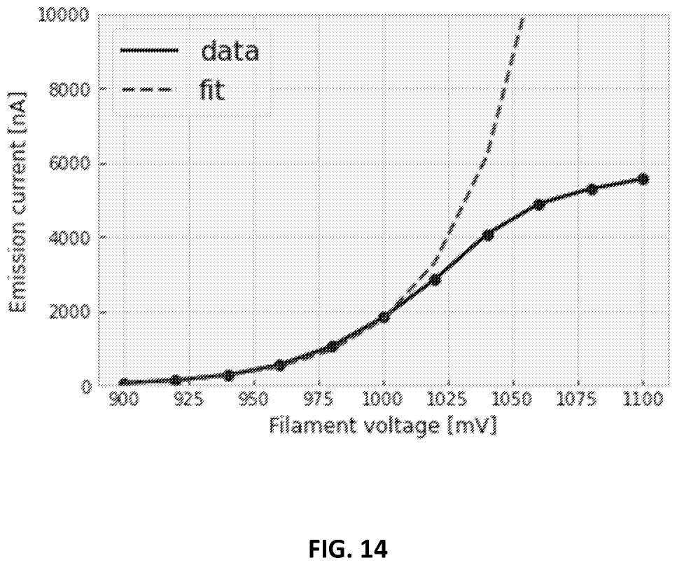

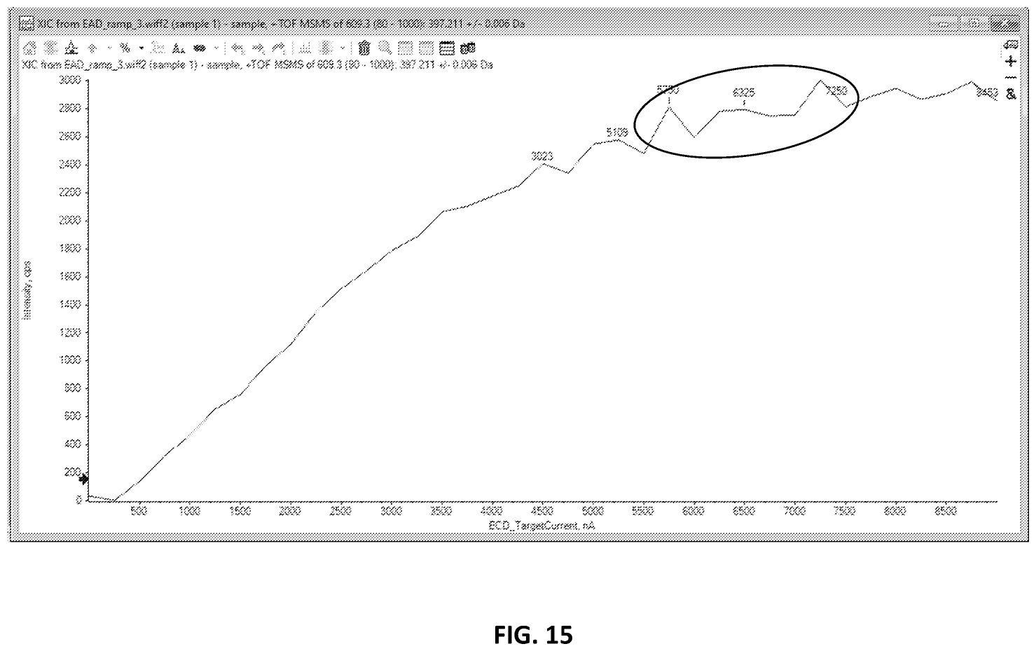

In some aspects, the filament drive voltage operating range can be determined to extend up to a maximum operating voltage, for example, representing the calibration saturation voltage plus an offset without risking damage to the filament. By way of example, FIG. 14 is a plot of the data of FIG. 10 that is back converted to the emission current/filament voltage domain (e.g., FIG. 9, the inverse log of FIG. 10). The dotted line of FIG. 14 represents the linear fit function obtained during the calibration procedure 1200 of FIG. 12 also back converted to the emission current/filament voltage domain. That is, the dotted line in FIG. 14 represents the equation of the fitted line depicted in FIG. 13B plotted in the emission current/filament voltage domain. Notably, the y-axis in FIG. 14 extends to 10000 nA, which may represent a maximum current threshold for the filament. Such a maximum current threshold can be determined in a variety of manners, for example, based on manufacturer suggestions as to the maximum drive current that can be supported by the filament or empirically in light of the effective range of drive current sufficient for efficient performance of EAD reactions. For example, FIG. 15 depicts data regarding the intensity of the main product ion [m/z 397.2] in a Reserpine EAD reaction relative to the electron emission current. Data is acquired at KE=6 eV, with the circled area of FIG. 15 representing the area where EAD reaction efficiency no longer substantially increases as the electron emission current increases, that is, where electron current saturation occurs. In some aspects, this current saturation value where EAD reaction efficiency no longer increases may be utilized to determine the maximum emission current threshold (e.g., 10000 nA in FIG. 14).

In various aspects, systems and methods in accordance with various aspects of the present teachings may utilize the operating range determined by the calibration procedures described herein during performance of ion-electron reactions. By way of example, during an ion-electron reaction, a controller can control the drive voltage applied to the filament such that the drive voltage is maintained within the operating range. It will also be appreciated by a person skilled in the art that the operating range of filament drive voltage that provides safe and efficient operation of the EAD device may alternatively be determined in the filament drive current domain. By way of example, the operating range of drive voltages may be mapped to the current domain. Thus, in various aspects, the filament drive voltage and/or current may be automatically controlled (e.g., under the control of controller 831) to be maintained within an operating range as determined in accordance with calibration procedures as otherwise discussed herein. Additionally or alternatively, systems and methods in accordance with the present teaching can also present the determined operating range of the filament drive voltage and/or current to a user (e.g., via a user interface of a display), for example, to allow the user to select a desired setting within the determined operating range.

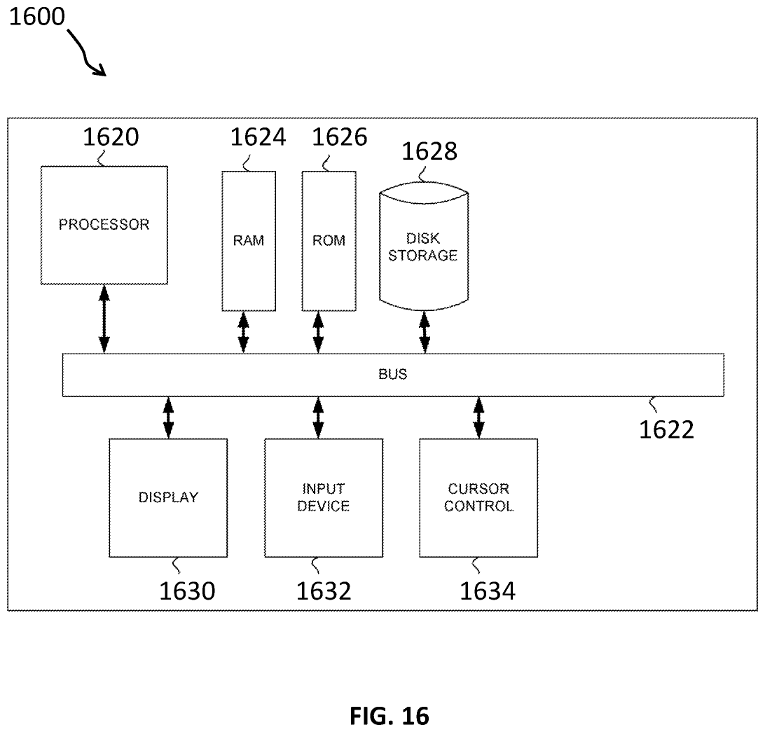

FIG. 16 is a block diagram that illustrates a computer system 1600, upon which embodiments of the present teachings may be implemented in accordance with various aspects of the applicant's teachings. Computer system 1600 includes a bus 1622 or other communication mechanism for communicating information, and a processor 1620 coupled with bus 1622 for processing information. Computer system 1600 also includes a memory 1624, which can be a random access memory (RAM) or other dynamic storage device, coupled to bus 1622 for storing instructions to be executed by processor 1620. Memory 1624 also may be used for storing temporary variables or other intermediate information during execution of instructions to be executed by processor 1620. Computer system 1600 further includes a read only memory (ROM) 1626 or other static storage device coupled to bus 1622 for storing static information and instructions for processor 1620. A storage device 1628, such as a magnetic disk or optical disk, is provided and coupled to bus 1622 for storing information and instructions.

Computer system 1600 may be coupled via bus 1622 to a display 1630, such as a cathode ray tube (CRT) or liquid crystal display (LCD), for displaying information to a computer user. An input device 1632, including alphanumeric and other keys, is coupled to bus 1622 for communicating information and command selections to processor 1620. Another type of user input device is cursor control 1634, such as a mouse, a trackball or cursor direction keys for communicating direction information and command selections to processor 1620 and for controlling cursor movement on display 1630. This input device typically has two degrees of freedom in two axes, a first axis (i.e., x) and a second axis (i.e., y), that allows the device to specify positions in a plane.

A computer system 1600 can perform the present teachings. Consistent with certain implementations of the present teachings, results are provided by computer system 1600 in response to processor 1620 executing one or more sequences of one or more instructions contained in memory 1624. Such instructions may be read into memory 1624 from another computer-readable medium, such as storage device 1628. Execution of the sequences of instructions contained in memory 1624 causes processor 1620 to perform the process described herein. Alternatively, hard-wired circuitry may be used in place of or in combination with software instructions to implement the present teachings. Thus, implementations of the present teachings are not limited to any specific combination of hardware circuitry and software. For example, the present teachings may be performed by a system that includes one or more distinct software modules for perform a method for operating an ion reaction device in accordance with various embodiments (e.g., a EAD reaction module, a calibration module).

In various embodiments, computer system 1600 can be connected to one or more other computer systems, like computer system 1600, across a network to form a networked system. The network can include a private network or a public network such as the Internet. In the networked system, one or more computer systems can store and serve the data to other computer systems. The one or more computer systems that store and serve the data can be referred to as servers or the cloud, in a cloud computing scenario. The one or more computer systems can include one or more web servers, for example. The other computer systems that send and receive data to and from the servers or the cloud can be referred to as client or cloud devices, for example.

The term “computer-readable medium” as used herein refers to any media that participates in providing instructions to processor 1620 for execution. Such a medium may take many forms, including but not limited to, non-volatile media, volatile media, and transmission media. Non-volatile media includes, for example, optical or magnetic disks, such as storage device 1628. Volatile media includes dynamic memory, such as memory 1624. Transmission media includes coaxial cables, copper wire, and fiber optics, including the wires that comprise bus 1624.

Common forms of computer-readable media or computer program products include, for example, a floppy disk, a flexible disk, hard disk, magnetic tape, or any other magnetic medium, a CD-ROM, digital video disc (DVD), a Blu-ray Disc, any other optical medium, a thumb drive, a memory card, a RAM, PROM, and EPROM, a FLASH-EPROM, any other memory chip or cartridge, or any other tangible medium from which a computer can read.

Various forms of computer readable media may be involved in carrying one or more sequences of one or more instructions to processor 1620 for execution. For example, the instructions may initially be carried on the magnetic disk of a remote computer. The remote computer can load the instructions into its dynamic memory and send the instructions over a telephone line using a modem. A modem local to computer system 1600 can receive the data on the telephone line and use an infra-red transmitter to convert the data to an infra-red signal. An infra-red detector coupled to bus 1622 can receive the data carried in the infra-red signal and place the data on bus 1622. Bus 1622 carries the data to memory 1624, from which processor 1620 retrieves and executes the instructions. The instructions received by memory 1624 may optionally be stored on storage device 1628 either before or after execution by processor 1620.

The following example is provided for further elucidation of various aspects of the present teachings and are provided only for illustrative purposes.

### Examples

All experiments were performed on a prototype ZenoTOF 7600 system equipped with branched-rf EAD cell. Triacetyl-β-cyclodextrin and reserpine were used to assess reproducibility of EAD fragmentation. A calibration strategy and software capability for detection of emission current saturation is developed based on finding the inflexion point in the emission graph.

In this example, a calibration strategy maps an electron emission at fixed kinetic energy to filament drive voltage. The automatic procedure safely terminates when the electron current saturation point is detected. Such an approach resolves issues with complicated filament control and yields an added benefit of significantly improved reproducibility of the experiments. This example demonstrates that the resulting electron emission range is safe and optimal with little benefit of driving the filament beyond the provided range for EAD applications.

The descriptions herein of various implementations of the present teachings have been presented for purposes of illustration and description. It is not exhaustive and does not limit the present teachings to the precise form disclosed. Modifications and variations are possible in light of the above teachings or may be acquired from practicing of the present teachings. Additionally, the described implementation includes software, though the present teachings may be implemented as a combination of hardware and software or in hardware alone. The present teachings may be implemented with both object-oriented and non-object-oriented programming systems.

The section headings used herein are for organizational purposes only and are not to be construed as limiting. While the applicant's teachings are described in conjunction with various embodiments, it is not intended that the applicant's teachings be limited to such embodiments. On the contrary, the applicant's teachings encompass various alternatives, modifications, and equivalents, as will be appreciated by those of skill in the art.

What is claimed is:

1. A method of operating an ion reaction device of a mass spectrometer system, comprising:
applying a calibration drive voltage to a filament of an electron emitter associated with an ion reaction cell;
determining a value representative of the calibration electron emission current generated by the filament while having the calibration drive voltage applied thereto;
determining a calibration saturation voltage by iteratively increasing the calibration drive voltage applied to the filament and determining the value of the calibration electron emission current at each corresponding calibration drive voltage until the filament reaches a saturation condition; and
based on said calibration saturation voltage, determining an operating range for a drive voltage applied to the filament.

2. The method of claim 1, wherein the operating range for the drive voltage is determined to be a range from 0 V to said calibration saturation voltage.

3. The method of claim 1, wherein the operating range for the drive voltage is determined to be a range from 0 V to said calibration saturation voltage plus an offset.

4. The method of claim 1, wherein determining the operating range comprises:
obtaining a linear fit calibration function of a plurality of values of the calibration electron emission current relative to the corresponding calibration drive voltages, wherein the calibration electron emission current is in log(I) domain; and
determining a maximum operating voltage using the linear fit calibration function and a predetermined emission current threshold,
wherein the operating range for the drive voltage is determined to be a range from 0 V to said maximum operating voltage.

5. The method of claim 1, wherein the predetermined emission current threshold is selected to be greater than or equal to an emission current at which ion-electron reaction efficiency is not substantially increased.

6. The method of claim 1, further comprising applying a drive voltage to the filament during an ion-electron reaction experiment performed within the ion reaction cell, wherein the applied drive voltage is controlled to be within the operating range.

7. The method of claim 6, further comprising allowing a user to select the drive voltage from the operating range during the ion-electron reaction experiment.

8. The method of claim 6, further comprising:
mapping the operating range for the drive voltage to a current domain; and
allowing a user to select a desired current from the operating range in the current domain.

9. The method of claim 1, wherein determining the value representative of the calibration electron emission current comprises measuring the current at an entry gate disposed between the electron emitter and electrodes of the ion reaction cell.

10. The method of claim 1, wherein the saturation condition is identified by a linear portion of the value representative of the calibration electron emission current on a log scale relative to the corresponding calibration drive voltage.

11. The method of claim 1, wherein the saturation condition is identified by an inflection point in a plot of the value representative of the calibration electron emission current versus the calibration drive voltage.

12. The method of claim 11, wherein the inflection point is identified by a change in a sign of a second derivative of the value representative of the calibration electron emission current.

13. A mass spectrometer, comprising:
an ion reaction cell configured to receive ions from an ion source;
an electron emitter configured to transmit into the ion reaction cell, the electron emitter having a filament configured to generate electrons when a drive voltage is applied thereto;
one or more voltage sources for providing the drive voltage to the filament; and
a controller, operably coupled to the one or more voltage sources, configured to:
apply a calibration drive voltage to the filament of the electron emitter;
determine a value representative of a calibration electron emission current generated by the filament while having the calibration drive voltage applied thereto;
determine a calibration saturation voltage by iteratively increasing the calibration drive voltage applied to the filament and determining the value of the calibration electron emission current at each corresponding calibration drive voltage until the filament reaches a saturation condition; and
based on said calibration saturation voltage, determine an operating range for the drive voltage applied to the filament during an ion-electron reaction experiment.

14. The mass spectrometer of claim 13, wherein the controller is further configured to determine the operating range by:
obtaining a linear fit calibration function of a plurality of values of the calibration electron emission current relative to the corresponding calibration drive voltages, wherein the calibration electron emission current is in log(I) domain; and
determining a maximum operating voltage using the linear fit calibration function and a predetermined emission current threshold,
wherein the operating range for the drive voltage is determined to be a range from 0 V to said maximum operating voltage.

15. The mass spectrometer of claim 13, wherein the controller is further configured to control the drive voltage to be within the operating range during an ion-electron reaction experiment performed within the ion reaction cell.

16. The mass spectrometer of claim 15, wherein the controller is further configured to receive an input from a user for selecting the drive voltage from the operating range during the ion-electron reaction experiment.

17. The mass spectrometer of claim 15, wherein the controller is further configured to:
map the operating range for the drive voltage to a current domain; and
receive an input from a user for selecting a desired emission current during the ion-electron reaction experiment.

18. The mass spectrometer of claim 13, wherein the ion reaction cell comprises:
a branched radiofrequency (RF) ion trap comprising eight L-shaped electrodes positioned axially at a distance relative to one another so as to provide an axial section exhibiting a central axis along which the ions are received from the ion source and two branched sections extending transversely from a central portion of said axial section and having a transverse axis along which electrons are received from the electron emitter.

19. The mass spectrometer of claim 18, further comprising a magnetic field generator that generates a magnetic field parallel to and along said transverse axis.

20. The mass spectrometer of claim 18, further comprising an entry gate disposed between the electron emitter and the branched sections of the L-shaped electrodes, wherein the value representative of the calibration electron emission current is measured at the entry gate.
